(19) United States
(12) Patent Application Publication
(10) Pub. No.: US 2007/0285425 A1
(43) Pub. Date: Dec. 13, 2007

(54) Reverse modeling method using mesh data as feature

(75) Inventors: Seock Hoon Bae, Seoul (KR); Dong Hoon Lee, Seoul (KR); Sung Wook Cho, Gyeonggi-Do (KR); Dong Hwa Kang, Seoul (KR); Joon Ho Seo, Seoul (KR)

Correspondence Address: HARNESS, DICKEY & PIERCE, P.L.C., P.O. BOX 828, BLOOMFIELD HILLS, MI, 48303, US

(73) Assignee: INUS TECHNOLOGY, INC.

(21) Appl. No.: 11/595,136

(22) Filed: Nov. 10, 2006

(30) Foreign Application Priority Data
Jun. 9, 2006 (KR) KR10-2006-0051939

(51) Int. Cl. G06T 15/20

(52) U.S. Cl. 345/427; 345/441

(57) ABSTRACT

A reverse modeling method using mesh data as a feature to allow reverse modeling to be conducted by following a procedure of an original designer includes the steps of detecting optional model data, setting the model data as a feature, and establishing a reference coordinate system of set mesh data; establishing a work plane on which a sketch of the set mesh data can be projected; projecting section data of the mesh data on the work plane; dividing data projected on the work plane into feature segments depending upon curvature distributions, and producing divided segments as sketch data; and producing a three dimensional feature from the sketch data which corresponds to a shape of the mesh data, and storing the produced three dimensional feature as model data, wherein the produced sketch data and three dimensional feature are parametrically connected with each other.

### BACKGROUND OF THE INVENTION

1. Field of the Invention

The present invention relates to a reverse modeling method using mesh data as a feature, and more particularly, to a reverse modeling method using mesh data as a feature, which uses mesh data as a feature such that reverse modeling can be conducted by following the procedure in which an original product designer designed a product using a three dimensional CAD program.

2. Description of the Prior Art

As is generally known in the art, in operation of a digital production system utilizing CAD/CAM/CAE, a digital model such as a three dimensional CAD model of a part is necessarily required. Specifically, representative fields in which reproduction work using reverse engineering is utilized typically includes a hand-made product, an old product having no design data due to the lapse of time, a competitor's product, and so on.

In order to incorporate the reproduction work process with the existing work scheme, reverse engineered model data must be supported to be recycled in a CAD system and must ensure product quality to allow mass production.

However, it is not easy to acquire reverse engineered data which can be utilized in an actual production site and can ensure product quality.

Also, the data acquired by scanning a product or a part may have errors to some extent when compared to those of a CAD model designed through an actual production process. Moreover, surrounding circumstances or an error rate of a scanner itself may change data during a scanning operation.

For these reasons, it is very difficult to create solid model data such as three dimensional CAD data, from scanned data, and in some cases, it may be impossible to create a solid model from scanned data.

Further, in the case of repeating operational processes in which a prototype model is scanned, simulated on a computer, physically processed and manually changed, the precise shape information of a digital model may be distorted in the course of conducting modification work, and a difference may be caused between a designed CAD model and the actual prototype model.

Furthermore, since the model data detected from the scanned data or by a method such as surface-fitting of a model, etc. are not parametrically connected with one another, when a user inputs new numerical information or corrects erroneous model data, only the corresponding specific portion of the data is changed or corrected, and other portions connected to the specific portion are not changed or corrected.

Moreover, a method for producing a patch based on curves is regarded as a technique which makes it easy to form a curve network and is therefore necessarily required in conducting curve processing operation. Curve extraction represents the function of automatically producing a curve. While the curve extraction provides an advantage in that time can be saved in conducting operation on the curve network, a problem is caused in that a user must designate respective curves as network curves.

Also, curve networks must be drawn on a mesh. Although this operation can configure curve networks as desired, an extended period and know-how is required, and, since parametricity is not ensured, it is not easy to conduct re-design or correction work.

While an automatic surface patch provides an advantage in that precise shape information can be acquired by detecting only the outer surface of mesh data, it is difficult to correct a produced surface. Further, as a number of patches are produced, it is difficult to adjust the quality of a surface.

Further, although convenience is provided in that a curve network is automatically produced, since it is difficult to modify a curve, a great deal of effort and time is required, and, since parametricity is not ensured, it is not easy to conduct re-design or correction work.

### SUMMARY OF THE INVENTION

Accordingly, the present invention has been made to solve the above-mentioned problems occurring in the prior art, and an object of the present invention is to provide a reverse modeling method using mesh data as a feature, which uses optional mesh data as a feature such that reverse modeling can be conducted by following the procedure in which an original product designer designed a product using a three dimensional CAD program.

In order to achieve the above object, according to one aspect of the present invention, there is provided a reverse modeling method using mesh data as a feature to allow reverse modeling to be conducted by following a procedure of an original designer, the method including the steps of a) detecting optional model data, setting the model data as a feature, and establishing a reference coordinate system of set mesh data; b) establishing a work plane on which a sketch of the set mesh data can be projected; c) projecting section data of the mesh data on the work plane for drawing a sketch; d) dividing data projected on the work plane for drawing a sketch into feature segments depending upon curvature distributions, and producing divided segments as sketch data; and e) producing a three dimensional feature from the sketch data which corresponds to a shape of the mesh data, and storing the produced three dimensional feature as model data, wherein the produced sketch data and three dimensional feature are parametrically connected with each other.

According to another aspect of the present invention, the method further includes the steps of producing a surface by adding a surface production region of the mesh data indicated by a user as a feature when surface production for the mesh data is requested from the user; and generating model data by conducting at least one of cutting, trim and merge for the produced surface and the three dimensional feature produced by the step e), and storing generated model data.

According to another aspect of the present invention, the reference coordinate system of the step a) is established by establishing a coordinate system of the mesh data based on coordinate information inputted from the user or by establishing a coordinate system based on the curvature distributions of the mesh data and geometric shapes according to the curvature distributions.

According to another aspect of the present invention, the three dimensional feature of the step e) is produced through conducting at least one solid modeling operation selected from the group consisting of extrude, fillet, chamfer, revolving, draft, mirroring, pattern, Boolean, swift, mating, and drawing.

According to another aspect of the present invention, when mesh data having a shape similar to that of the optional mesh data is inputted, the mesh data having the similar shape is rebuilt through the same procedure in which the optional mesh data is reversely modeled, by establishing the same coordinate system as that of the optional mesh data established in the step a).

According to another aspect of the present invention, each of the segments divided in the step d) includes one selected from the group consisting of a straight line, a circle, an arc, a free curve, a rectangle, a polygon, and a slot.

According to another aspect of the present invention, the segments are parametrically connected with one another by the fact that constraint and numerical information are established according to connections between the respective segments.

According to another aspect of the present invention, the constraint and numerical information are conditions which are fitted from the feature segments of the two dimensional projected section data including a straight line, a circle, an arc, a free curve, a rectangle, a polygon and a slot, or which are set by the user to satisfy at least one of verticality, horizontality, parallelism, slopeness, junction, fixing, correspondence, the same straight line, concentricity, the same radius, and the same distance between the feature segments.

According to another aspect of the present invention, the segments are automatically established in accordance with an internal tolerance between the segments or are manually established or corrected by data inputted from the user.

According to another aspect of the present invention, when a change occurs in the mesh data divided into the segments, a segment of the mesh data which is changed and other segments which are parametrically connected with the changed segment are automatically rebuilt.

According to another aspect of the present invention, a final result obtained by automatic rebuilding is automatically updated.

In order to achieve the above object, according to another aspect of the present invention, there is provided a reverse modeling method using mesh data as a feature to allow reverse modeling to be conducted by following a procedure of an original designer, the method including the steps of i) detecting optional model data, setting the model data as a feature, and establishing a reference coordinate system of set mesh data; ii) obtaining curvature distributions of the mesh data, classifying geometric information of the mesh data based on the curvature distributions, and dividing the mesh data into feature regions depending upon the classified geometric information; iii) establishing a work plane on which a sketch of the mesh data divided into feature regions can be projected; iv) projecting section data of the mesh data on the work plane for drawing a sketch, dividing data projected on the work plane for drawing a sketch into feature segments depending upon the curvature distributions, and producing divided segments as sketch data; and v) producing a three dimensional feature on which a shape of the mesh data is reflected, based on the sketch data and the feature regions of the mesh data which are divided in the step ii), wherein the produced sketch data and three dimensional feature are parametrically connected with each other.

According to another aspect of the present invention, the method further includes the steps of producing a surface by adding a surface production region of the mesh data indicated by a user as a feature when surface production for the mesh data is requested from the user; and generating model data by conducting at least one of cutting, trim and merge for the produced surface and the three dimensional feature produced by the step v), and storing generated model data.

According to another aspect of the present invention, the reference coordinate system of the step i) is established by establishing a coordinate system of the mesh data based on coordinate information inputted from the user or by establishing a coordinate system based on the curvature distributions of the mesh data and geometric shapes according to the curvature distributions.

According to another aspect of the present invention, the feature regions divided in the step ii) can be redivided in compliance with redivision request from the user.

According to another aspect of the present invention, the feature regions divided in the step ii) are displayed as geometric information which is provided with different colors depending upon the curvature distributions.

According to another aspect of the present invention, the three dimensional feature of the step v) on which the shape of the mesh data is reflected is produced up to boundaries of points which constitute the feature regions.

According to another aspect of the present invention, each segment includes one selected from the group consisting of a straight line, a circle, an arc, a free curve, a rectangle, a polygon, and a slot, and the segments are parametrically connected with one another by the fact that constraint and numerical information are established according to connections between the respective segments.

According to still another aspect of the present invention, when a change occurs in the mesh data divided into the segments, a segment of the mesh data which is changed and other segments which are parametrically connected with the changed segment are automatically rebuilt.

According to a still further aspect of the present invention, when mesh data having a shape similar to that of the optional mesh data is inputted, the mesh data having the similar shape is rebuilt through the same procedure in which the optional mesh data is reversely modeled, by establishing the same coordinate system as that of the optional mesh data established in the step i).

### BRIEF DESCRIPTION OF THE DRAWINGS

The above and other objects, features and advantages of the present invention will be more apparent from the following detailed description when taken in conjunction with the accompanying drawings, in which:

FIG. 1 is a block diagram illustrating the construction of a reverse modeling system using mesh data as a feature in accordance with the present invention;

FIG. 2 is a flow chart illustrating a reverse modeling method using mesh data as a feature in accordance with the present invention;

FIG. 3 is a view illustrating optional mesh data in accordance with the present invention;

FIG. 4 is a view illustrating a process for determining features for the mesh data shown in FIG. 3;

FIG. 5 is a view illustrating a process for projecting a section silhouette of the mesh data shown in FIG. 3 on a work plane for sketching;

FIG. 6 is a view illustrating the section silhouette projected on the work plane;

FIG. 7 is a view illustrating a process for determining the section silhouette projected on the work plane;

FIG. 8 is a view illustrating a process for determining the numerical information of the section silhouette projected on the work plane;

FIG. 9 is a view illustrating a process for generating a three dimensional feature from regions separated from completed sketch data;

FIG. 10 is a view illustrating an extrude feature including the three dimensional feature shown in FIG. 9;

FIG. 11 is a flow chart illustrating a reverse modeling method using mesh data as a feature in accordance with another embodiment of the present invention;

FIG. 12 is a view illustrating a process for classifying feature regions from information regarding curvatures and geometries of mesh data; and

FIG. 13 is a view illustrating a process for generating an extrude feature from mesh data to the classified feature regions.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

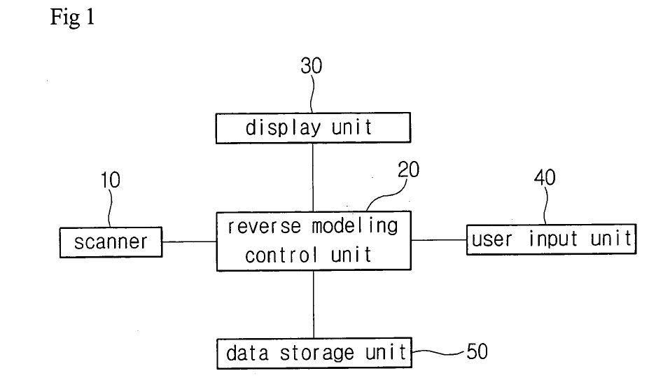

FIG. 1 is a block diagram illustrating the construction of a reverse modeling system using mesh data as a feature in accordance with the present invention. Referring to FIG. 1, the system for detecting a reverse modeling object includes a scanner 10 for measuring the reverse modeling object, a reverse modeling control unit 20 for controlling the entire modeling system and performing a reverse modeling function, a display unit 30 for outputting scan data detected from the scanner 10 or mesh data produced by transforming the scan data (hereinafter, referred to as “mesh data”) to allow a user to confirm the data, a user input unit 40 for detecting setting data inputted by the user, and a data storage unit 50 for storing reverse modeling data detected from the mesh data.

The scanner 10 is a component part for acquiring scan data through measuring the reverse modeling object, and preferably, includes a three dimensional scanner.

In the present invention, the reverse modeling object includes point cloud data detected from the scanner 10, the scan data, the mesh data produced by transforming the scan data, general CAD data, CAD data having curved surfaces, and polylines produced in a variety of ways by connecting line segments through graphics in an external device such as a computer.

The reverse modeling control unit 20 analyzes optional mesh data or point cloud data (hereinafter, referred to as “mesh data”), establishes the X-axis, Y-axis and Z-axis of the inputted mesh data depending upon the reference coordinate system information inputted from the user input unit 40, and causes the mesh data to be recognized as one feature.

That is to say, since the mesh data is recognized as one feature, all features produced from the mesh data are influenced, and, if a correction is made on the mesh feature, rebuilding of an entire reverse modeling procedure is implemented and a final reverse model is automatically updated, as a result of which parametricity is accomplished.

Also, it is possible to automatically establish a reference coordinate system for optional mesh data. In other words, as the reverse modeling control unit 20 analyzes the curvature distributions of the mesh data and divides the mesh data into regions over each of which a uniform curvature distribution is detected, it is possible to extract the surface and axis information from the divided regions and to find an optimal coordinate system from the extracted surface and axis information.

Further, the reverse modeling control unit 20 places a work plane for drawing a sketch on a section to provide a sketch of the established mesh data, and then projects the section data of the mesh data onto the work plane for drawing a sketch.

Here, the reverse modeling control unit 20 analyzes the data projected on the work plane for drawing a sketch depending upon the curvature distributions to produce and store two dimensional sketch data, and, as a result of the analysis, divides the segments, for example, into a straight line, a circle, an arc, a free curve, a rectangle, a polygon, a slot, etc. Then, the reverse modeling control unit 20 detects the coordinate system information and numerical information of the segments.

Here, the curvature means a rate of change in the direction of a curved line, which is mediated by the length of an arc. Depending upon the curvature distributions of the two dimensional section data of the mesh data projected on the work plane for drawing a sketch, two dimensional projected section data which is composed of straight lines, circles, arcs, free curves, rectangles, polygons, slots, etc. can be displayed.

The reverse modeling control unit 20 parametrically establishes the connection relationships of the segments by using the numerical information of the detected segments as parameters, and displays the established segments and numerical information on the display unit 30.

The display unit 30 displays the mesh data, the reference coordinate system automatically established by the reverse modeling control unit 20, information regarding the directions of the X-axis, Y-axis and Z-axis, which is inputted from the user input unit 40, the work plane for drawing a sketch produced by the reverse modeling control unit 20, the section data projected on the work plane for drawing a sketch, the sketch elements produced based on the projected section data, and a three dimensional solid modeling feature produced from the sketch elements. While an extrude feature is illustrated as the three dimensional modeling feature in the present embodiment, the three dimensional modeling feature can produce modeling data by conducting at least one of cutting, trim and merge.

The user input unit 40 includes input means such as a keyboard, a mouse, etc. The user input unit 40 inputs establishment information for establishing the reference coordinate system of the mesh data displayed on the display unit 30, instructions for inputting and correcting the numerical information of the mesh data, and various information for producing the extrude feature.

The data storage unit 50 stores the mesh data, the extrude feature, that is, the three dimensional reverse modeling data produced by the reverse modeling control unit 20, etc.

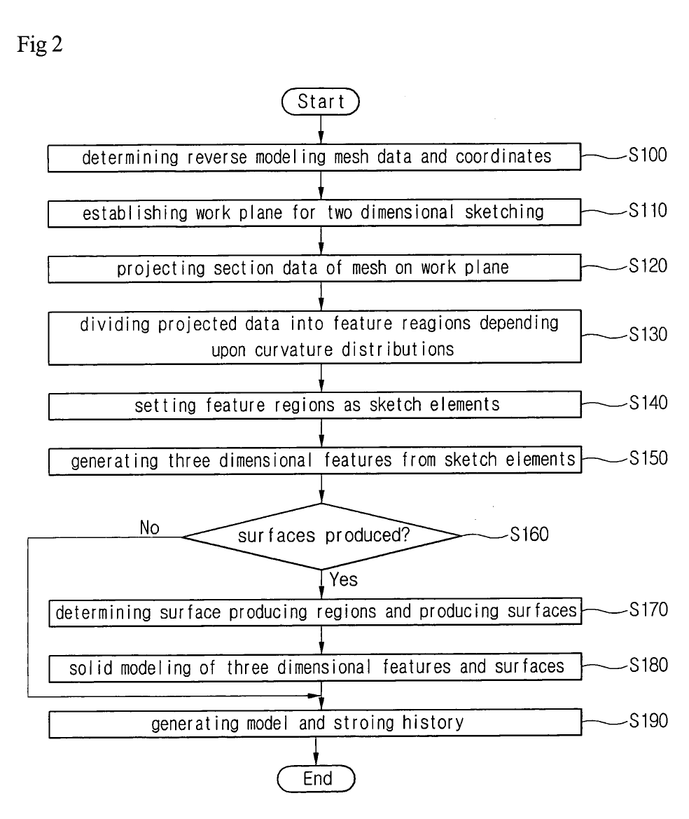

FIG. 2 is a flow chart illustrating a reverse modeling method using mesh data as a feature in accordance with the present invention. The reverse modeling method using mesh data as a feature will be described below with reference to FIGS. 1 and 2.

The reverse modeling control unit 20 for conducting reverse modeling of the mesh data detects the mesh data through the scanner 10 or an external device (for example, a computer system). In order to establish the coordinate system of the detected optional mesh data, as the reverse modeling control unit 20 analyzes the curvature distributions of the mesh data and divides the mesh data into regions over each of which a uniform curvature distribution is detected, the reference coordinate system is automatically established based on the divided regions or the reference coordinate system having the X-axis, Y-axis and Z-axis of the mesh data depending upon the reference coordinate system information inputted from the user input unit 40 is established, and the established mesh data is recognized as one feature (S100).

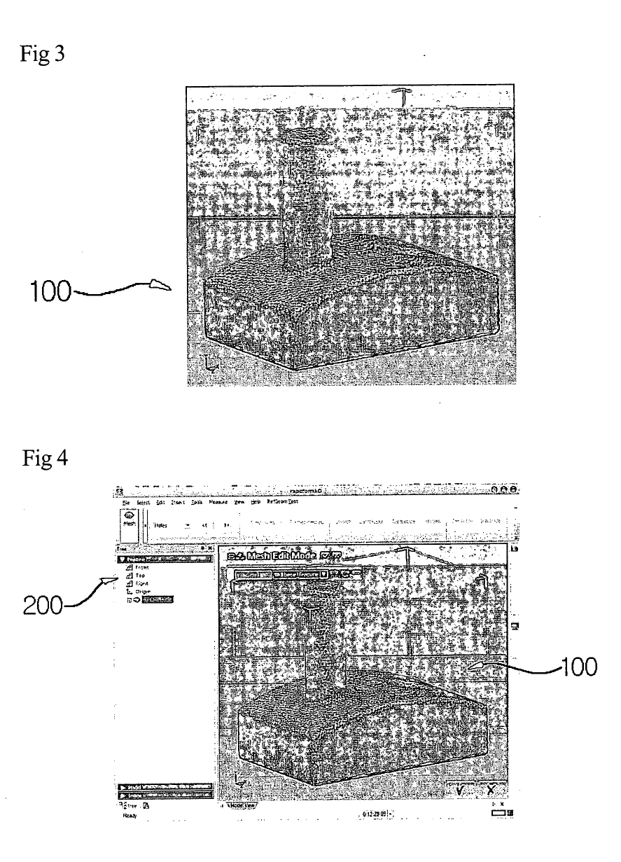

That is to say, as shown in FIG. 3, the reference coordinate system is established by introducing optional mesh data 100 or point cloud data, and the established mesh data is registered as one feature.

At this time, by analyzing the curvature distributions of the mesh data and dividing the mesh data into regions over each of which a uniform curvature distribution is detected, it is possible to extract the surface and axis information from the divided regions and to find an optimal coordinate system from the extracted surface and axis information.

Also, in a usual way of establishing the reference coordinate system, three reference surfaces, for example, an X-Y plane, a Y-Z plane and a Z-X plane are established, a local coordinate system is created at a position where the respective surfaces are crossed with one another, and the created local coordinate system is correlated with a global coordinate system.

Additional ways of establishing the reference coordinate system, in the case where the CAD data of the reverse modeling object exists, include a method of minimizing the distance between the curved surface of the CAD data and the points of the model data, and a method of finding the reference points predefined in the CAD data and the corresponding points on the model data and minimizing the distance between these points.

Further, in the case of editing the mesh data 100, as shown in FIG. 4, by selecting the menu 200 of a tree through the user input unit 40, a portion (for example, unclear point cloud, a mesh region, etc.) desired by the user may be added or corrected through edition such as deletion.

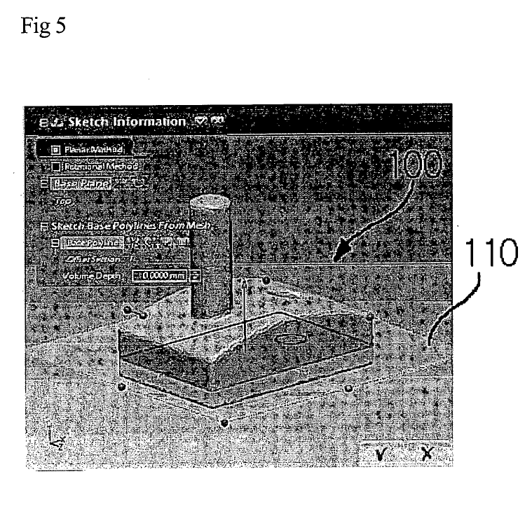

After step S100 is implemented, as shown in FIG. 5, the reverse modeling control unit 20 places a work plane 110 for drawing a sketch on a section arranged for a draft of the sketch of the established mesh data 100 (S110).

Namely, the work plane 110 on which two dimensional sketch data is prepared is established through the same procedure as a designer who initially designed a reverse modeling object conducts a modeling operation for the reverse modeling object, and the position of the section to be the sketch of the sketch data is determined.

At this time, the optimal position of the section to be the sketch of the sketch data is determined in a manner such that the work plane 110 for drawing a sketch can be moved on the mesh data 100 while the user views the sectional shape of the mesh data 100 displayed in real time on the work plane 110 for drawing a sketch.

After step S110 is implemented, the reverse modeling control unit 20 projects the section data of the mesh data 100 on the work plane for drawing a sketch 110 (S120), and divides the data projected on the work plane 110 for drawing a sketch into feature segments depending upon curvature distributions (S130).

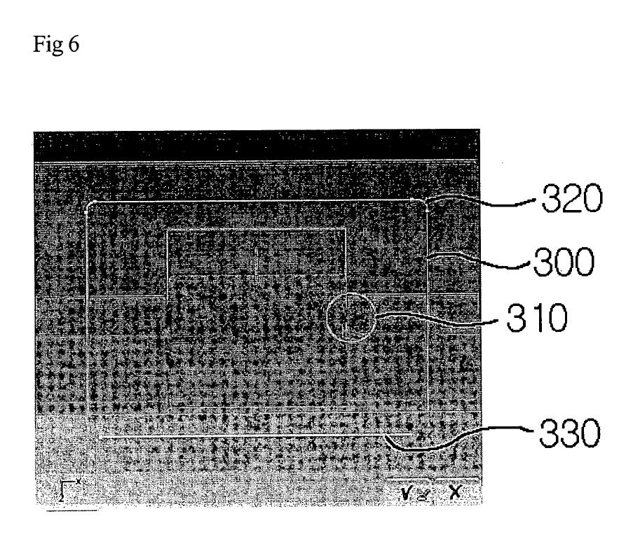

As best shown in FIG. 6, the section data of the mesh data is projected on the work plane for drawing a sketch at a position indicated by the user, and the data projected on the work plane for drawing a sketch is divided into segments such as a straight line, a circle, an arc, a free curve, a rectangle, a polygon, a slot, etc.

That is to say, as a result of analyzing the section data projected on the work plane 110 for drawing a sketch, the reverse modeling control unit 20 divides a first segment 300 and a fourth segment 330 which are analyzed to have the curvatures of a plane curve into straight lines, and a second segment 310 which is analyzed to have the curvature of a circle into a circle and a third segment 320 which is analyzed to have the curvature of an arc into an arc, and displays the first through fourth segments 300 through 330.

These segments are parametrically connected with one another so that, when a change occurs in the mesh data divided into the segments, a segment of the mesh data which is changed and other segments which are parametrically connected with the changed segment are automatically rebuilt, and the final result which is obtained by automatic rebuilding is updated.

In other words, in a state in which the verticality, horizontality, parallelism, tangent, etc. are maintained in the segments acting as sketch elements, the dimensional information of the respective segments can be searched again and rebuilt, and the result can be stored.

Meanwhile, the segments are automatically divided using a well-known technique for analyzing the curvature distributions in the reverse modeling control unit 20, and the divided segments can be manually reestablished in conformity with the selection of the user.

After step S130 is implemented, the reverse modeling control unit 20 produces the respective divided segments as sketch data (S140).

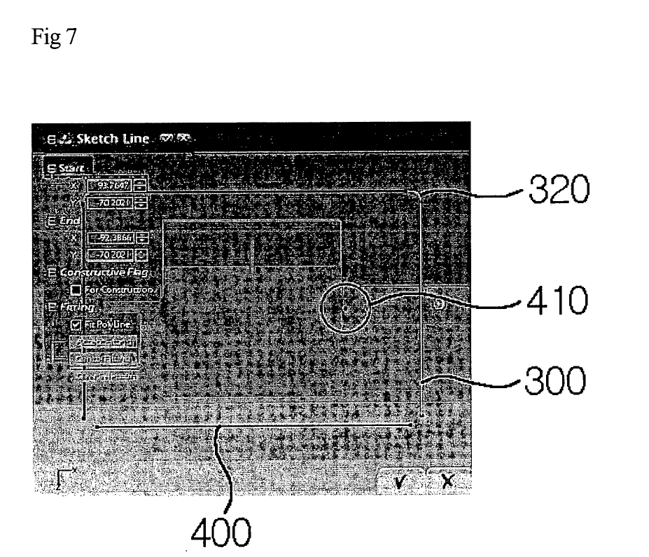

As shown in FIG. 7, the section data of the mesh data which is automatically divided can be automatically transformed such as into a first sketch element 400 and a second sketch element 410, and the first segment 300 and the third segment 320 which are indicated by the user can be manually transformed.

The reason why the sketch elements indicated by the user are manually reestablished is because, differently from the intention of an actual designer, the segments produced by being automatically divided on the work plane 110 for drawing a sketch may be produced at positions which are slightly deviated from the reference coordinate system, without any predefined constraints (for example, verticality, horizontality, parallelism, slopeness, junction, fixing, correspondence, the same straight line, concentricity, the same radius, the same distance, and so forth, between the segments of the projected section data).

That is to say, the ending points between the respective segments of the projected section data are separated from one another, and values such as a length, a radius, and the like, have some errors when compared to originally designed dimensions. This is to automatically connect the ending points using internal tolerances in the reverse modeling control unit 20 or manually connect the ending points by the user, and to allow the ending points to be automatically or manually established depending upon dimensions and constraint.

Moreover, when conducting a manual establishing operation, by using a snapping function which automatically fixes the cursor of a mouse in the vicinity of the ending point or the boundary of the projected section data, the segment indicated by the user can be properly selected and fixed to the ending point.

Thereafter, if the user moves the cursor of the mouse from the fixed ending point to the ending point of another newly established segment, the cursor of the mouse is fixed through snapping to the ending point of the segment to be connected, by which a new sketch element can be established by the user.

Further, it is possible to set a slope so that two lines are automatically tangential to each other when the direction of a slope at an ending point approaches within an angle predetermined by the reverse modeling control unit 20, and an angle, a length, a radius, and so forth, can be automatically set based on rules such as rounding to the nearest whole number, rounding off, etc.

Due to this fact, it is possible to solve the problems caused due to the fact that, in order to produce two dimensional sketch data, an operation must be conducted by opening two dimensional image having no dimensional concept or by directly measuring various dimensions of an actual product.

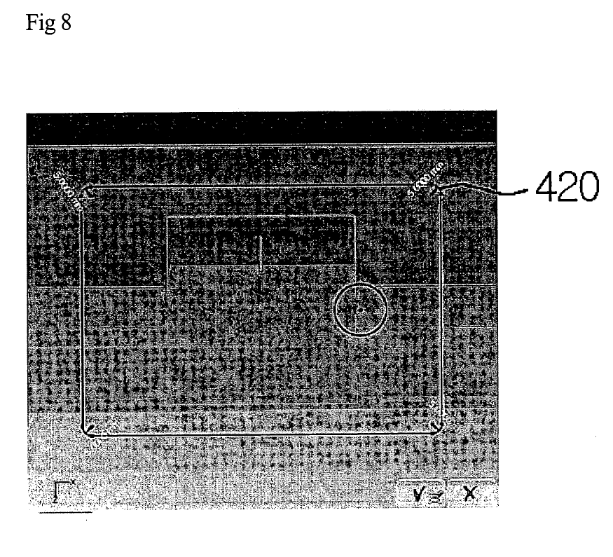

Accordingly, sketch data as shown in FIG. 8 is produced by the automatically or manually transformed sketch elements, and at this time, various dimensions such as of the third sketch element 420 can be automatically acquired.

After step S140 is implemented, the reverse modeling control unit 20 produces a three dimensional modeling feature by producing a three dimensional feature depending upon the shape of the mesh data, from the completed sketch data (S150).

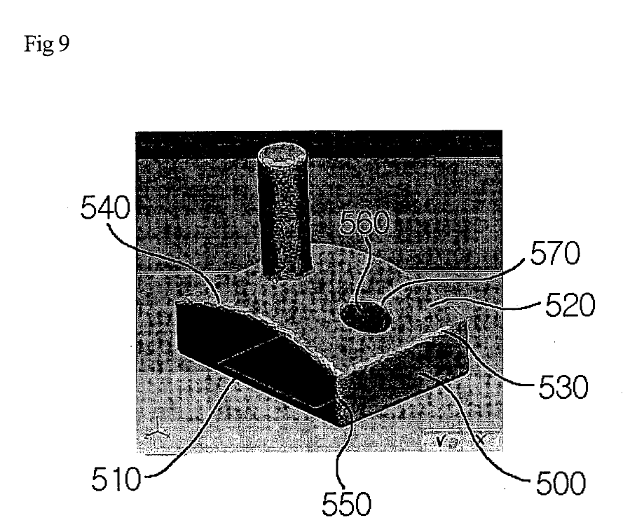

That is to say, as shown in FIG. 9, by conducting ‘extrude’ in an upward or downward direction based on the sketch data transformed into a plurality of sketch elements 400 through 430, a three dimensional extrude feature is added to the two dimensional sketch elements, and modeling of the reverse modeling object is conducted through the same procedure as that of the initial designer which designed the reverse modeling object. Here, the three dimensional feature can be produced through conducting at least one selected from the group consisting of extrude, fillet, chamfer, revolving, draft, mirroring, pattern, Boolean, swift, mating, and drawing.

Meanwhile, in the case where the mesh data serving as the reverse modeling object has a formalized shape (for example, a hexahedron, a rectangular parallelepiped, a sphere, etc.), by implementing step S150, model data can be produced. In the case where the mesh data serving as the reverse modeling object has a non-formalized shape, that is, a free form, or mesh data for detecting feature regions is not sufficient, by using a feature for feature regions which is added by the user, the feature for the feature shape of the mesh data can be added.

Therefore, the reverse modeling control unit 20 determines whether a request for surface production of the mesh data is inputted from the user input unit 40 (S160). As a result of the determination in step S160, when a surface production region for surface production is inputted from the user, fitting is established for the surface production region of the mesh data inputted from the user, and a surface is produced for the established surface production region (S170).

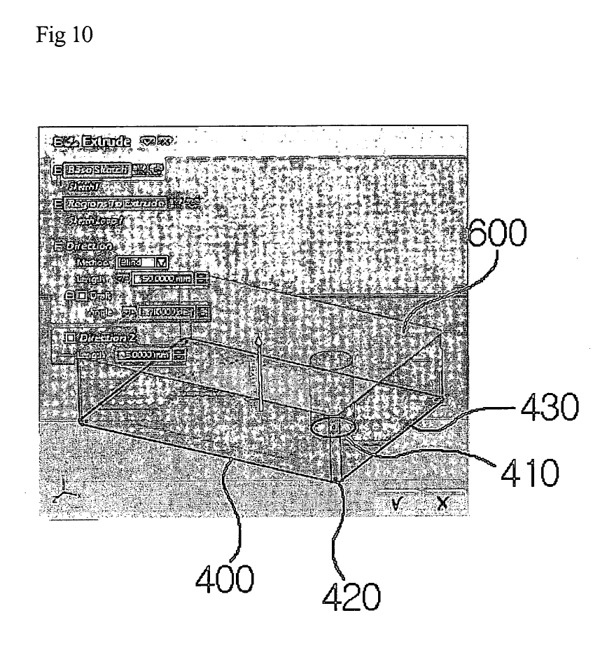

That is to say, when producing modeling data 700 as shown in FIG. 10, a first feature 710, which has the formalized shape of a rectangular parallelepiped, and a second feature 720, which is located on the upper end of the first feature 710 and has a non-formalized free shape of a curve, are created.

In order to establish the surface 720, the reverse modeling control unit 20 establishes the upper curved surface of the mesh data which is indicated by the user, as feature regions for producing a surface.

At this time, the established feature regions are automatically divided depending upon the curvature distributions of the mesh data, and the automatically divided feature regions can be corrected by the user.

Meanwhile, the surface can be produced on the mesh data, can be produced in a manner such that the user draws the region for surface production as a closed curve through a drawing program, or can be produced by establishing polylines optionally determined by the user or a third feature shape detected from another mesh data as a surface production region.

Thereafter, based on the established surface production region, the reverse modeling control unit 20 produces a surface for the free shape.

After step S170 is implemented, the reverse modeling control unit 20 produces modeling data including one feature by conducting at least one of cutting, trim, and merge for the three dimensional feature produced in step S150 and the surface produced in step S170 (S190).

That is to say, by coupling the first feature 710 having the shape of a rectangular parallelepiped and the surface 720 positioned in the feature region of the first feature having the shape of a rectangular parallelepiped to constitute one feature and then by cutting all of the feature portions of the first feature 710 which are positioned beyond the surface 720 and therefore are not necessary, modeling data 700 is produced.

The history implemented by the steps S100 through S190 in the reverse modeling control unit 20 and the modeling data produced in step S190 are stored together in the data storage unit 50.

Here, the reverse modeling procedure is stored to eliminate inconvenience which is caused due to the fact that the user must conduct again the reverse modeling procedure when mesh data having a shape similar to that of the reversely modeled mesh data is inputted. By matching the coordinate systems of the mesh data having the similar shape and the reversely modeled mesh data, the mesh data having the similar shape can be rebuilt through the same reverse modeling procedure as that of the reversely modeled mesh data, and the final rebuilt result is automatically updated and stored in the data storage unit 50.

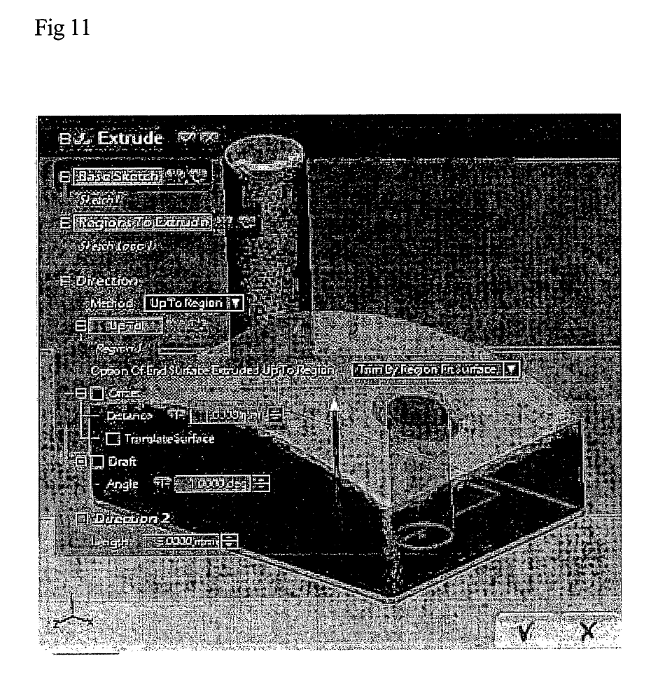

FIG. 11 is a flow chart illustrating a reverse modeling method using mesh data as a feature in accordance with another embodiment of the present invention.

Referring to FIGS. 1 and 11, the reverse modeling control unit 20 for conducting reverse modeling of the mesh data detects the mesh data through the scanner 10 or an external device (for example, a computer system). In order to establish the coordinate system of the detected optional mesh data, the reverse modeling control unit 20 analyzes the curvature distributions of the mesh data and divides the mesh data into regions over each of which a uniform curvature distribution is detected. Then, based on the divided regions, the surface and axis information are extracted from the divided regions, and an optimal coordinate system is found from the extracted surface and axis information. In this way, the reference coordinate system is automatically established or the reference coordinate system having the X-axis, Y-axis and Z-axis of the mesh data depending upon the reference coordinate system information inputted from the user input unit 40 is established, and the established mesh data is recognized as one feature (S200).

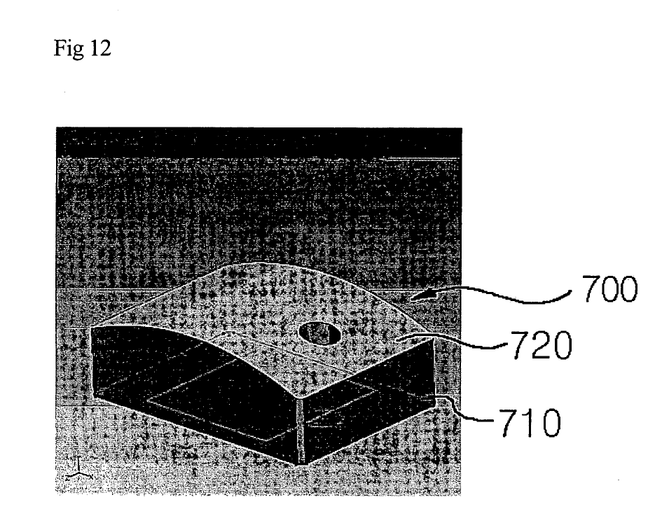

After step S200 is implemented, as shown in FIG. 12, the reverse modeling control unit 20 obtains the curvature distributions of the acquired mesh data 100, classifies the geometric information of the mesh data based on the curvature distributions (S210), and divides the mesh data into feature regions depending upon the classified geometric information (S220).

That is to say, shape features of the mesh data 100 depending upon the curvature distributions and geometric information are divided into first through eighth feature regions 500 through 570, and the divided feature regions indicate the feature characteristics of the mesh data.

Concretely speaking, depending upon the curvature distributions (for example, a flat surface, a curved surface, etc.) and geometrical shapes (a triangle, a rectangle, a polygon, a circle, an arc, etc.), the mesh data 100 can be divided into a first feature region 500 which has a rectangular shape, a second feature region 510 which has an arc on the upper portion thereof, a third feature region 520 which has a rectangular shape, a seventh feature region 560 which has a hollow cylindrical shape, a fourth feature region 530 which has an arc or a fillet formed between the first and third feature regions 500 and 520, a fifth feature region 540 which is formed between the second and third feature regions 510 and 520, a sixth feature region 550 which is formed between the first and second feature regions 500 and 510, and an eighth feature region 570 which is formed between the third and seventh feature regions 520 and 560.

These feature regions allow various solid modeling operations (for example, extrude, fillet, chamfer, revolving, etc.) for producing a feature needed for conducting the reverse modeling operation, to be easily carried out.

Also, the feature regions may be differentiated from one another by using different colors depending upon the curvature distributions of the mesh data. The reverse modeling control unit 20 can automatically divide the mesh data into the feature regions, or the feature regions, which are selected among the automatically divided feature regions according to a division establishment request inputted from the user input unit 40, can be reestablished into the same or different regions.

For example, in the case where the fourth and sixth feature regions 530 and 550 which are divided as different feature regions have the same curvature distribution and geometric information, the user can reestablish the fourth and sixth feature regions 530 and 550 into the feature regions having the same characteristic.

After step S220 is implemented, the reverse modeling control unit 20 places a work plane for drawing a sketch on a section to provide a sketch of the established mesh data (S230).

After the section data of the mesh data is projected on the work plane for drawing a sketch and the data projected on the work plane for drawing a sketch is divided into feature segments depending upon curvature distributions, the respective divided segments are produced as sketch data (S240).

After step S240 is implemented, the reverse modeling control unit 20 produces a three dimensional feature on which the shape of the mesh data is reflected, based on the sketch data produced in step S240 and the feature regions of the mesh data divided in step S220 (S250).

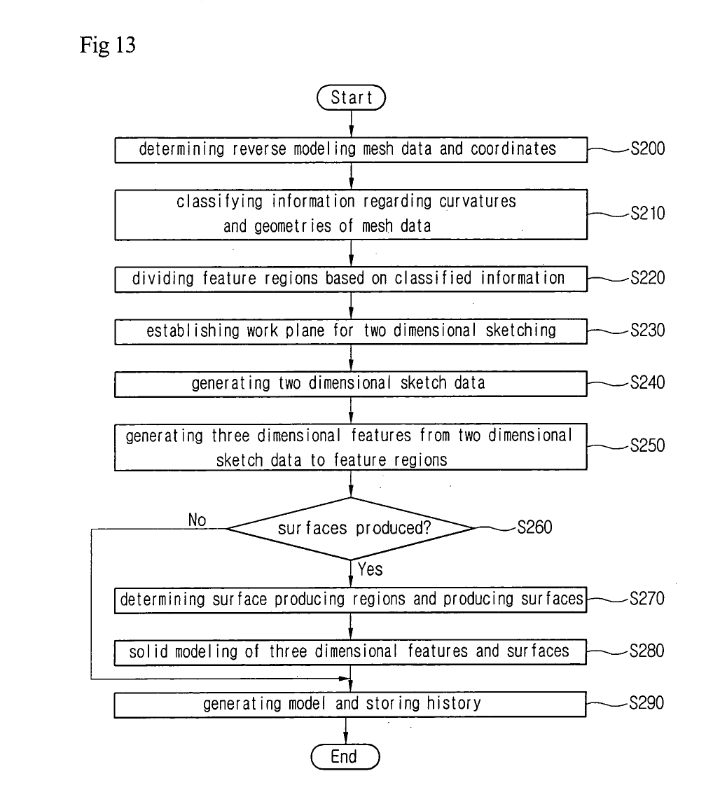

As shown in FIG. 13, when producing the three dimensional feature from the sketch data, the reverse modeling control unit 20 produces the three dimensional feature, that is, an extrude feature, only up to the divided feature regions. In other words, the shape of the mesh is allowed to be reflected through the feature regions.

Meanwhile, the three dimensional feature can be produced through conducting at least one selected from the group consisting of extrude, fillet, chamfer, revolving, draft, mirroring, pattern, Boolean, swift, mating, and drawing.

The three dimensional feature, on which the shape of the mesh data is reflected, is produced up to the boundary of the points constituting the feature regions, through snapping for automatically fixing the cursor of a mouse in the vicinity of the feature regions.

Also, the produced sketch data and the three dimensional feature are parametrically connected with each other, so that, when even one of the segments or feature regions divided from the mesh data is changed, other segments or feature regions connected with the changed segment or feature region can be rebuilt.

Meanwhile, in the case where the mesh data serving as the reverse modeling object has a formalized shape (for example, a hexahedron, a rectangular parallelepiped, a sphere, etc.), by implementing step S250, model data can be produced. In the case where the mesh data serving as the reverse modeling object has a non-formalized shape, that is, a free form, or mesh data for detecting feature regions is not sufficient, by using fitting for feature regions which are added by the user, a feature for the shape of the mesh data can be added.

The reverse modeling control unit 20 determines whether a request for surface production of the shape of the mesh data is inputted from the user input unit 40 (S260). As a result of the determination in step S260, when a surface production region for surface production is inputted from the user, the surface production region of the mesh data inputted from the user is produced as a surface (S270).

Referring to FIG. 10, when producing modeling data 700, a first feature 710, which has the formalized shape of a rectangular parallelepiped, and a second feature 720, which is located on the upper end of the first feature 710 and has a non-formalized free shape of a curve, are created.

In order to establish the surface 720, the reverse modeling control unit 20 establishes the upper curved surface of the mesh data which is indicated by the user, as feature regions for producing a surface.

At this time, the established feature regions are automatically divided depending upon the curvature distributions of the mesh data, and the automatically divided feature regions can be corrected by the user.

Thereafter, based on the established surface production region, the reverse modeling control unit 20 produces a surface for the free shape.

Referring again to FIGS. 1 and 11, after step S270 is implemented, the reverse modeling control unit 20 produces modeling data including one feature by conducting at least one of cutting, trim, and merge (S280) for the three dimensional feature produced in step S250 and the surface produced in step S270 (S290).

That is to say, by allowing modeling data to be produced up to the first feature having the shape of a rectangular parallelepiped and the surface positioned in the feature region of the first feature having the shape of a rectangular parallelepiped, modeling data 700 is produced.

The history implemented by the steps S200 through S290 in the reverse modeling control unit 20 and the modeling data produced in step S290 are stored together in the data storage unit 50.

Here, the reverse modeling procedure is stored to eliminate inconvenience which is caused due to the fact that the user must conduct again the reverse modeling procedure when mesh data having a shape similar to that of the reversely modeled mesh data is inputted. By matching the coordinate systems of the mesh data having the similar shape and the reversely modeled mesh data, the mesh data having the similar shape can be rebuilt through the same reverse modeling procedure as that of the reversely modeled mesh data, and the final rebuilt result is automatically updated and stored in the data storage unit 50.

Also, it is possible to cause the fitting surface of the reverse engineered mesh data to be rebuilt in correspondence with the mesh data having a similar shape.

As is apparent from the above descriptions, the present invention provides advantages in that reverse modeling can be conducted based on the mesh data of a reverse modeling object by following the procedure in which an original product designer designed a product using a three dimensional CAD program.

Since a reverse modeling task is conducted based on the mesh data of the reverse modeling object, the efficiency of the modeling work is improved, and the time of modeling work is shortened.

Also, in the present invention, because the features established in the course of conducting the reverse modeling task are parametrically connected with one another, they can be automatically updated when a condition or information is newly set or changed.

Moreover, due to the fact that a reverse modeling procedure is stored, when mesh data having a shape similar to that of the reverse engineered mesh data is inputted, it is not necessary for a user to repeat the reverse modeling procedure, and the mesh data can be rebuilt in a short period.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A reverse modeling method using mesh data as a feature to allow reverse modeling to be conducted by following a procedure of an original designer, the method comprising the steps of:
a) detecting optional model data, setting the model data as a feature, and establishing a reference coordinate system of set mesh data;
b) establishing a work plane on which a sketch of the set mesh data can be projected;
c) projecting section data of the mesh data on the work plane for drawing a sketch;
d) dividing data projected on the work plane for drawing a sketch into feature segments depending upon curvature distributions, and producing divided segments as sketch data; and
e) producing a three dimensional feature from the sketch data which corresponds to a shape of the mesh data, and storing the produced three dimensional feature as model data,
wherein the produced sketch data and three dimensional feature are parametrically connected with each other.

2. The method as set forth in claim 1, further comprising the steps of:
producing a surface by adding a surface production region of the mesh data indicated by a user as a feature when surface production for a feature region of the mesh data is requested from the user; and
generating model data by conducting at least one of cutting, trim and merge for the produced surface and the three dimensional feature produced by step e), and storing generated model data.

3. The method as set forth in claim 1, wherein the reference coordinate system of step a) is established by establishing a coordinate system of the mesh data based on coordinate information inputted from the user or by establishing a coordinate system based on the curvature distributions of the mesh data and geometric shapes according to the curvature distributions.

4. The method as set forth in claim 1, wherein the three dimensional feature of step e) is produced through conducting at least one solid modeling operation selected from the group consisting of extrude, fillet, chamfer, revolving, draft, mirroring, pattern, Boolean, swift, mating, and drawing.

5. The method as set forth in claim 1, wherein, when mesh data having a shape similar to that of the optional mesh data is inputted, the mesh data having the similar shape is rebuilt through the same procedure in which the optional mesh data is reversely modeled, by establishing the same coordinate system as that of the optional mesh data established in step a).

6. The method as set forth in claim 1, wherein each of the segments divided in step d) comprises one selected from the group consisting of a straight line, a circle, an arc, a free curve, a rectangle, a polygon, and a slot.

7. The method as set forth in claim 6, wherein the segments are parametrically connected with one another by the fact that constraint and numerical information are established according to connections between the respective segments.

8. The method as set forth in claim 7, wherein the constraint and numerical information are conditions which are fitted from the feature segments of the two dimensional projected section data including a straight line, a circle, an arc, a free curve, a rectangle, a polygon and a slot, or which are set by the user to satisfy at least one of verticality, horizontality, parallelism, slopeness, junction, fixing, correspondence, the same straight line, concentricity, the same radius, and the same distance between the feature segments.

9. The method as set forth in claim 7, wherein the segments are automatically established in accordance with an internal tolerance between the segments or are manually established or corrected by data inputted from the user.

10. The method as set forth in claim 6, wherein, when a change occurs in the mesh data divided into the segments, a segment of the mesh data which is changed and other segments which are parametrically connected with the changed segment are automatically rebuilt.

11. The method as set forth in claim 10, wherein a final result obtained by automatic rebuilding is automatically updated.

12. A reverse modeling method using mesh data as a feature to allow reverse modeling to be conducted by following a procedure of an original designer, the method comprising the steps of:
i) detecting optional model data, setting the model data as a feature, and establishing a reference coordinate system of set mesh data;
ii) obtaining curvature distributions of the mesh data, classifying geometric information of the mesh data based on the curvature distributions, and dividing the mesh data into feature regions depending upon the classified geometric information;
iii) establishing a work plane on which a sketch of the mesh data divided into feature regions can be projected;
iv) projecting section data of the mesh data on the work plane for drawing a sketch, dividing data projected on the work plane for drawing a sketch into feature segments depending upon the curvature distributions, and producing divided segments as sketch data; and
v) producing a three dimensional feature on which a shape of the mesh data is reflected, based on the sketch data and the feature regions of the mesh data which are divided in step ii),
wherein the produced sketch data and three dimensional feature are parametrically connected with each other.

13. The method as set forth in claim 12, further comprising the steps of:
producing a surface by adding a surface production region of the mesh data indicated by a user as a feature when surface production for the mesh data is requested from the user; and
generating model data by conducting at least one of cutting, trim and merge for the produced surface and the three dimensional feature produced by step v), and storing generated model data.

14. The method as set forth in claim 12, wherein the reference coordinate system of step i) is established by establishing a coordinate system of the mesh data based on coordinate information inputted from the user or by establishing a coordinate system based on the curvature distributions of the mesh data and geometric shapes according to the curvature distributions.

15. The method as set forth in claim 12, wherein the feature regions divided in step ii) can be redivided in compliance with redivision request from the user.

16. The method as set forth in claim 12, wherein the feature regions divided in step ii) are displayed as geometric information which is provided with different colors depending upon the curvature distributions.

17. The method as set forth in claim 12, wherein the three dimensional feature of step v) on which the shape of the mesh data is reflected is produced up to boundaries of points which constitute the feature regions.

18. The method as set forth in claim 12, wherein each segment comprises one selected from the group consisting of a straight line, a circle, an arc, a free curve, a rectangle, a polygon, and a slot, and the segments are parametrically connected with one another by the fact that constraint and numerical information are established according to connections between the respective segments.

19. The method as set forth in claim 17, wherein, when a change occurs in the mesh data divided into the segments, a segment of the mesh data which is changed and other segments which are parametrically connected with the changed segment are automatically rebuilt.

20. The method as set forth in claim 12, wherein, when mesh data having a shape similar to that of the optional mesh data is inputted, the mesh data having the similar shape is rebuilt through the same procedure in which the optional mesh data is reversely modeled, by establishing the same coordinate system as that of the optional mesh data established in step i).
